(19) United States
(12) Patent Application Publication
(10) Pub. No.: US 2025/0026390 A1
(43) Pub. Date: Jan. 23, 2025

(54) Battery Transport Equipment

(71) Applicant: SHANGHAI YUJET, CO. LTD., Kunshan City (CN)

(72) Inventor: Yu TIAN, Hong Kong (HK)

(21) Appl. No.: 18/419,101

(22) Filed: Jan. 22, 2024

Related U.S. Application Data
(63) Continuation-in-part of application No. 18/314,058, filed on May 8, 2023, now Pat. No. 11,912,376.
(60) Provisional application No. 63/480,716, filed on Jan. 20, 2023.
(60) Provisional application No. 63/480,716, filed on Jan. 20, 2023.

(30) Foreign Application Priority Data
Jul. 8, 2022 (CN) 202210804854.X
Jul. 8, 2022 (CN) 202210805802.4
Jul. 8, 2022 (CN) 202210807458.2
Jul. 8, 2022 (CN) 202210807921.3
Jul. 8, 2022 (CN) 202210808130.2
Jul. 8, 2022 (CN) 202210808181.5
Jul. 8, 2022 (CN) 202210815527.4
Jul. 8, 2022 (CN) 202210815528.9
Oct. 28, 2022 (CN) 202211331990.8
Oct. 28, 2022 (CN) 202211332030.3
Oct. 28, 2022 (CN) 202211332542.X
Oct. 28, 2022 (CN) 202211332654.5
Oct. 28, 2022 (CN) 202211332676.1
Oct. 28, 2022 (CN) 202211341386.3
Oct. 28, 2022 (CN) 202211341387.8
Oct. 28, 2022 (CN) 202211341848.1

(51) Int. Cl. B62B 1/26; B60H 1/00; B60L 53/60; B62B 1/10; B62B 5/00; B62B 5/06; H02J 7/00

(52) U.S. Cl. CPC B62B 1/26; B60H 1/00357; B62B 1/10; B62B 5/00; B62B 5/067; H02J 7/0045; B60L 53/60; B60L 2200/32; B62B 2202/61; B62B 2204/04

(57) ABSTRACT

A battery transportation equipment to transport a plurality of backup batteries. The battery transportation equipment includes: rollers, an equipment body, a battery cavity and a cooling device. The rollers are connected to the equipment body; the battery cavity is formed by an inward recess of the equipment body; the battery cavity is used to accommodate the plurality of backup batteries and is provided with a pairs of outwardly extending power plugs. The power plugs are used to plug-connect with the power jacks of the backup battery. The cooling device surrounds the battery cavity to dissipate heat when the plurality of backup batteries are being charged.

### CROSS-REFERENCES

This application claims priority to, and is a non-provisional application of, U.S. provisional application No. 63/480,716, filed Jan. 20, 2023.

This application is a continuation-in-part application of U.S. utility patent application Ser. No. 18/314,058, filed on May 8, 2023, now allowed, which claims priority to, and is a non-provisional patent application of, U.S. provisional patent application No. 63/480,716, filed on Jan. 20, 2023, all of which is hereby incorporated by reference in their entireties.

This application is a continuation-in-part application of U.S. utility patent application Ser. No. 18/314,058, filed on May 8, 2023, now allowed, which claims priority to China Invention Patent Application number 202211332654.5, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332676.1, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341386.3, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341387.8, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211341848.1, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332030.3, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211332542.X, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202211331990.8, filed on Oct. 28, 2022, now pending, which is hereby expressly incorporated by reference as part of the present disclosure.

This application is a continuation-in-part application of U.S. utility patent application Ser. No. 18/314,058, filed on May 8, 2023, filed on May 8, 2023, now allowed, which claims priority to China Invention Patent Application number 202210807458.2, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, filed on May 8, 2023, now allowed, which claims priority to China Invention Patent Application number 202210805802.4, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210804854.X, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210807921.3, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210815528.9, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210808130.2, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210808181.5, filed on Jul. 8, 2022, now pending, which is hereby expressly incorporated by reference as part of the present disclosure.

This application is a continuation-in-part application of U.S. utility patent application Ser. No. 18/314,058, filed on May 8, 2023, now allowed, which claims priority to China Invention Patent Application number 202210815527.4, filed on Jul. 8, 2022, now pending, which is hereby expressly incorporated by reference as part of the present disclosure.

### FIELD OF THE DISCLOSURE

The invention relates to the technical field of surfing equipment, in particular to a battery transport equipment for transporting batteries for electric surfboards.

### BACKGROUND OF THE INVENTION

Currently, the batteries of electric surfboards and other water equipment on the market are very heavy, which are very difficult for users to carry. Therefor there is an urgent need for a better way to transport batteries for electric surfboards.

### SUMMARY OF THE INVENTION

The purpose of the invention is to provide a battery transportation equipment. The battery transportation equipment of the present application is used to transport a plurality of backup batteries of the surfboard and other water equipment at the same time, and able to charge a plurality of backup batteries at the same time, and it can dissipate heat from the battery during charging and improve charging efficiency.

For this purpose, the invention provides a battery transportation equipment, used to transport a plurality of backup batteries, the battery transportation equipment comprising: rollers, an equipment body, a battery cavity and a cooling device; wherein the rollers are connected to the equipment body, the battery cavity is formed by an inward recess of the equipment body; the battery cavity is used to accommodate the plurality of backup batteries and is provided with a plurality of pairs of outwardly extending power plugs at the bottom. the power plugs are used to plug-connect with the power jacks of the backup battery, the cooling device surrounds the battery cavity, the cooling device is used to dissipate heat when the plurality of backup batteries are being charged.

Moreover, the cooling device includes a plurality of cooling fans, the plurality of cooling fans are provided on a side of the equipment body, the plurality of cooling fans are connected to the battery cavity and are used to discharge the air flow inside the equipment body.

Moreover, a plurality of ventilation holes are provides on a side of the equipment body, and the plurality of ventilation holes are connected to the battery cavity.

Moreover, the equipment body further includes a control part, a control cavity is provides inside the control part, and a control module is set in the control cavity, the control module is used to control the charging of the backup battery.

Moreover, a connected hole is provided between the control cavity and the battery cavity.

Moreover, a plurality of heat dissipation holes are provided on a side of the control part, and the heat dissipation holes are connected to the control cavity.

Moreover, the plurality of cooling fans includes a plurality of first fans and a plurality of second fans, the first fans are connected to the battery cavity and are used to discharge the air flow inside the battery cavity, and the second fans are connected to the control cavity and are used to discharge the air flow inside the control cavity.

Moreover, a pull rod is provided on the top of the battery transportation equipment, and the pull rod can be telescopic.

Moreover, the equipment body further include a cover, the cover is used to open or close the battery cavity.

Moreover, the battery cavity is separated by at least a division plate.

The battery transportation equipment of the present application is used to transport a plurality of backup batteries of the surfboard and other water equipment at the same time, and able to charge a plurality of backup batteries at the same time, and it can dissipate heat from the battery during charging and improve charging efficiency.

### BRIEF DESCRIPTION OF DRAWINGS

FIG. 1 shows the schematic structural diagram of the battery transportation equipment provided by the embodiment of the present invention;

FIG. 2 shows the schematic structural diagram of the cover of the battery transportation equipment in a closed state provided by the embodiment of the present invention;

FIG. 3 shows the schematic structural diagram of the control cavity of the battery transportation equipment provided by the embodiment of the present invention;

FIG. 4 shows the schematic structural diagram of division plate of the battery transportation equipment provided by the embodiment of the present invention.

### DETAILED DESCRIPTION

The different aspects of the various embodiments can now be better understood by turning to the following detailed description of the embodiments, which are presented as illustrated examples of the embodiments as defined in the claims. It is expressly understood that the embodiments as defined by the claims may be broader than the illustrated embodiments described below.

It will, nevertheless, be understood that no limitation of the scope of the disclosure is thereby intended; any alterations and further modifications of the described or illustrated embodiments and any further applications of the principles of the disclosure as illustrated therein are contemplated as would normally occur to one skilled in the art to which the disclosure relates.

The technical solutions of the present invention will be further described below in conjunction with the accompanying drawings and embodiments. It should be understood that the specific embodiments described here are only used to explain the present invention, but not to limit the present invention. In addition, it should be noted that, for the convenience of description, only the parts related to the present invention are shown in the drawings but not all of them.

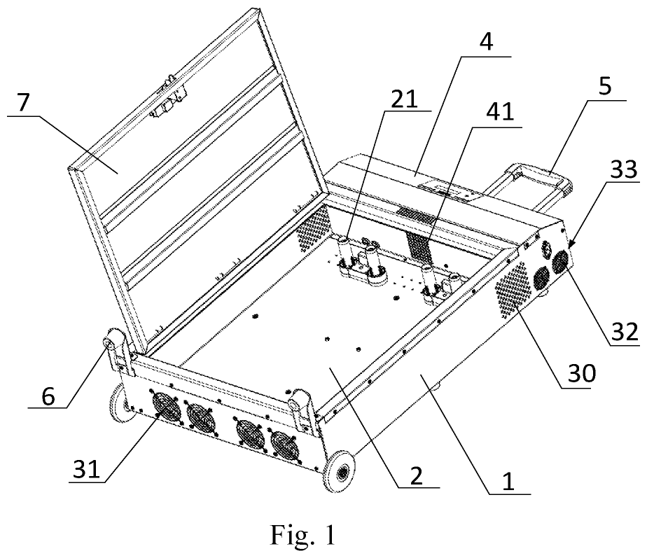

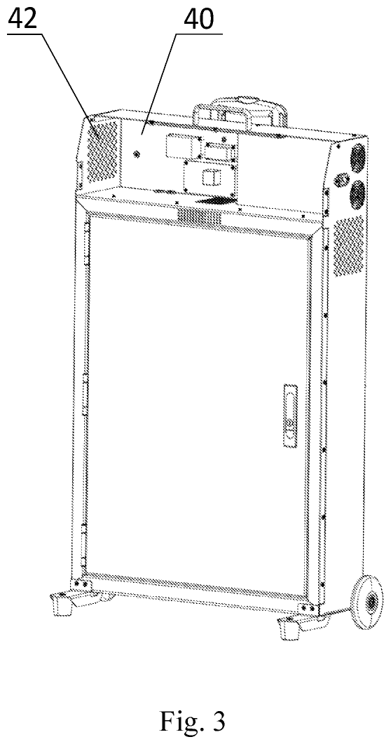

The following describes embodiments of the present application with reference to the accompanying drawings. As shown in FIGS. 1 to 3, the battery transportation equipment in the embodiment of the present application is used to transport a plurality of backup batteries, and is able to charge a plurality of backup batteries at the same time. The battery transportation equipment includes: rollers, an equipment body 1, a battery cavity 2 and a cooling device 3. The rollers are connected to the feet of the equipment body 1 to facilitate the transportation of the equipment. The number of rollers can be one pair as shown in FIG. 1, or of course two pairs.

The battery cavity 2 is formed by an inward recess of the equipment body 1. The battery cavity 2 is used to accommodate the plurality of backup batteries and is provided with a plurality of pairs of outwardly extending power plugs 21 at the bottom. The power plugs 21 are used to plug-connect with the power jacks of the backup battery. When the backup batteries is placed in the battery cavity 2, the power plug 21 is electrically connected to the power jack. The cooling device 3 surrounds the battery cavity 2, since the battery generates heat when charging, the cooling device 3 is used to dissipate heat from the backup battery.

Specifically, the cooling device 3 includes a plurality of cooling fans. The plurality of cooling fans are set on a side of the equipment body 1 and the cooling fans are connected to the battery cavity 2 in the equipment body 1. When the battery is being charged, the plurality of cooling fans are used to discharge the hot air flow in the equipment body 1. The equipment body 1 further includes a control part 4. The control part 4 includes a control cavity 40 inside. The control cavity 40 is provided with a control module, the control module is used to control the charging of the backup battery. The control module is used to transform and stabilize the external power supply, and deliver the generated stable current to the power plug 21.

In this embodiment, the plurality of cooling fans includes a plurality of first fans 31 and a plurality of second fans 32. The first fans 31 are connected to the battery cavity 2 and are used to discharge the air flow in the battery cavity 2. The second fans 32 are connected to the control cavity 40 and are used to discharge the air flow in the control cavity 40. A plurality of ventilation holes 30 are provides on a side of the equipment body 1. The ventilation holes 30 are connected to the battery cavity 2. The ventilation holes 30 are preferably located on both sides of the equipment body 1. The ventilation holes 30 can be used as the air inlet of the battery cavity 2, and the cold air from the outside can enter the battery cavity 2 through the ventilation hole 30 and then discharged through the first fans 31.

A plurality of heat dissipation holes 42 are provides on a side of the control part 4, and the heat dissipation holes 42 are connected to the control cavity 4. The heat dissipation holes 42 can be used as the air inlet of the control cavity 40, and the cold air from the outside can enter the control cavity 40 through the heat dissipation holes 42, and then discharged through the second fans 32. Furthermore, A connected hole 41 can also be provided between the control cavity 40 and the battery cavity 2 to increase internal air flow and improve heat dissipation efficiency.

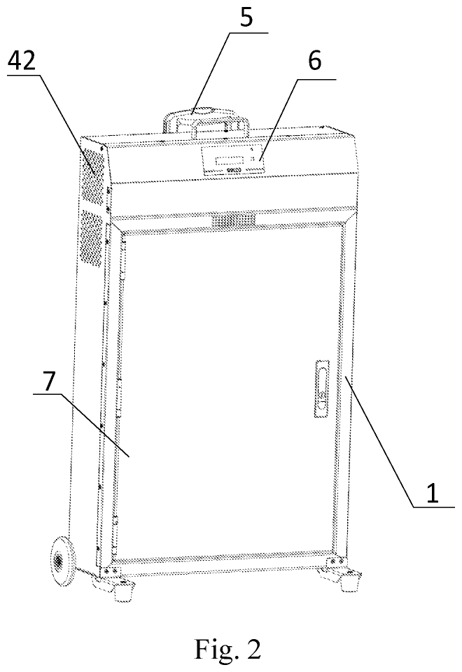

Furthermore, as shown in FIGS. 1 and 2, a pull rod 5 is provided on the top of the battery transportation equipment. The pull rod 5 can be telescopic, and the battery transportation equipment can be pulled to roll forward through the pull rod 5 and the roller 4, which is convenient and labor-saving.

Furthermore, as shown in FIG. 2, a display 6 is provided on the control part 4 to display the charging status of the backup battery, so that the charging status can be checked at any time.

Furthermore, as shown in FIG. 2, the equipment body 1 is further provided with a cover 7, which is used to open or close the battery cavity 2 to prevent the battery inside from sliding out when the equipment is moved.

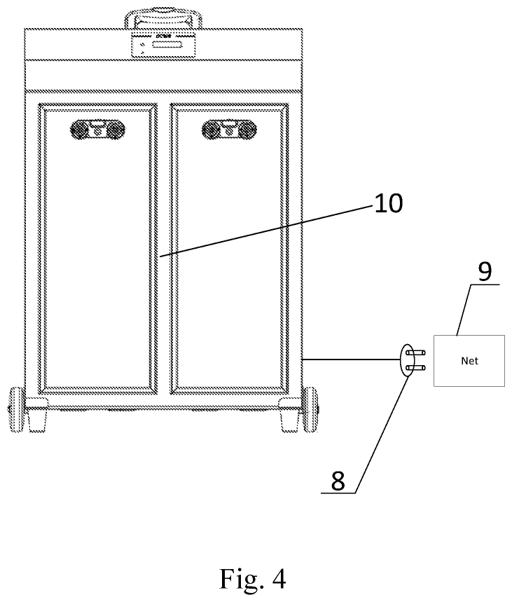

Furthermore, as shown in FIG. 4, the battery transportation equipment further includes a charging plug 8, The charging plug 8 is used to connect to the municipal power grid 9 or other power supply networks.

Furthermore, as shown in FIG. 1, a pair of rollers and a pair of supporting feet can be provided at the bottom of the battery transportation equipment, so that the battery transportation equipment can be placed vertically for convenient storage.

Further, as shown in FIG. 4, in some embodiments, the battery cavity 2 is separated by a division plate 10. The division plate 10 can prevent the two backup batteries from interfering with each other as much as possible.

The battery transportation equipment of the present application is used to transport a plurality of backup batteries of the surfboard and other water equipment at the same time, and able to charge a plurality of backup batteries at the same time, and it can dissipate heat from the battery during charging and improve charging efficiency.

It should be noted that more than two pairs of power plugs 21 can be provided in the battery cavity 2 to accommodate more than one pair of backup batteries, which is not limited here.

The above embodiments only illustrate the principles and effects of the present application. Anyone familiar with this technology can modify or change the above embodiments without violating the purpose of this application. Therefore, all equivalent modifications or changes made by those with ordinary skill in the art without departing from the purpose disclosed in this application shall still be covered by the claims of this application.

1. A battery transportation equipment to transport a plurality of backup batteries, the battery transportation equipment comprising:
a plurality of rollers disposed at a bottom of the transportation equipment;
an equipment body;
a battery cavity; and
a cooling device;
wherein the plurality of rollers are connected to the equipment body; the battery cavity is formed by an inward recess of the equipment body; the battery cavity is used to accommodate the plurality of backup batteries and is provided with a pair of outwardly extending power plugs;
wherein the pair of power plugs is used to plug-connect with a power jack of the backup battery;
wherein the cooling device surrounds the battery cavity; the cooling device dissipates heat when the plurality of backup batteries are being charged.

2. The battery transportation equipment according to claim 1, wherein the cooling device includes a plurality of cooling fans, the plurality of cooling fans are provided on a side of the equipment body, the plurality of cooling fans are connected to the battery cavity and are used to discharge an air flow inside the equipment body.

3. The battery transportation equipment according to claim 1, further comprising a plurality of ventilation holes provided on a side of the equipment body, and the plurality of ventilation holes are connected to the battery cavity.

4. The battery transportation equipment according to claim 3, wherein the equipment body further includes a control part, a control cavity is provided inside the control part, and a control module is set in the control cavity; wherein the control module is used to control a charging of the backup battery.

5. The battery transportation equipment according to claim 4, further comprising a connected hole between the control cavity and the battery cavity.

6. The battery transportation equipment according to claim 1, wherein a plurality of heat dissipation holes are provided on a side of the control part, and the plurality of heat dissipation holes are connected to the control cavity.

7. The battery transportation equipment according to claim 4, wherein the plurality of cooling fans includes a first fan and a second fan, the first fan is connected to the battery cavity and discharges an air flow inside the battery cavity, and the second fan is connected to the control cavity to discharge an air flow inside the control cavity.

8. The battery transportation equipment according to claim 1, wherein a pull rod is provided on a top of the battery transportation equipment, and the pull rod is telescopic.

9. The battery transportation equipment according to claim 1, wherein the equipment body further include a cover, the cover is used to open or close the battery cavity.

10. The battery transportation equipment according to claim 1, wherein the battery cavity is separated by at least a division plate.
